(19) United States
(12) Patent Application Publication
(10) Pub. No.: US 2026/0112256 A1
(43) Pub. Date: Apr. 23, 2026

(54) Method and Apparatus for Monitoring a Motor Vehicle

(71) Applicant: Bayerische Motoren Werke Aktiengesellschaft, Muenchen (DE)

(72) Inventors: David Kragl, Zolling (DE); Marcel Sieber, Muenchen (DE); Benjamin Schuster, Muenchen (DE); Stephan Ludwig, Muenchen (DE); David Hearn, Garching bei Muenchen (DE)

(21) Appl. No.: 19/117,036

(22) PCT Filed: Jun. 28, 2023
(86) PCT No.: PCT/EP2023/067618

§ 371 Date: Mar. 29, 2025

(30) Foreign Application Priority Data
Oct. 19, 2022 (DE) 10 2022 127 609.0

(51) Int. Cl. G08B 15/00; B60Q 1/50; B60Q 5/00; G01P 15/08; G06V 20/52; G06V 20/56; G08B 7/06

(52) U.S. Cl. CPC G08B 15/005; B60Q 1/543; B60Q 5/005; G01P 15/08; G06V 20/52; G06V 20/56; G08B 7/06

(57) ABSTRACT

A method monitors a motor vehicle that contains a sensor system for detecting vandalism which is inflicted on the motor vehicle by at least one attacking person. The method includes issuing a warning via a user interface of a terminal device assigned to the motor vehicle to inform a user of the detected vandalism. The method also includes enabling one or more control instructions to be selected by the user of the user interface when the warning is issued. An action of the motor vehicle is assigned to a respective selectable control instruction, wherein the action includes a visual and/or acoustic signal output on the motor vehicle for warning the attacking person. When a first respective control instruction is selected by the user, triggered by the terminal device, the action assigned to the first respective selected control instruction is carried out by the motor vehicle.

The present application is the U.S. national phase of PCT Application PCT/EP2023/067618 filed on Jun. 28, 2023, which claims priority of German patent application No. 10 2022 127 609.0 filed on Oct. 19, 2022, the entire contents of which are incorporated herein by reference.

### TECHNICAL FIELD

The present disclosure relates to the field of monitoring motor vehicles.

### BACKGROUND

It is known from the prior art that the condition of a motor vehicle is monitored by means of a suitable sensor system of the motor vehicle. For example, the document DE 10 2016 006 037 A1 discloses a method for recording an environment of a vehicle, wherein vandalism inflicted on the vehicle is recorded with a suitable sensor system and, as a consequence, the recording of image data of the environment is activated.

Document DE 10 2016 003 845 A1 describes a method for warning a driver of a vehicle with the soft top down, wherein precipitation and vandalism on the vehicle are detected and the driver is informed about this by means of a warning on his terminal device. The soft top can then be closed by means of the terminal device. The closing of the soft top is monitored by a camera of the vehicle.

The known methods used to detect vandalism of a motor vehicle inform the driver of the motor vehicle, but they do not provide any mechanisms to stop the vandalism as quickly as possible.

There is a need, therefore, for a method and an arrangement for monitoring a motor vehicle which improves protection against vandalism compared to conventional methods.

### SUMMARY

The above-stated needs, as well as others, are addressed by at least some embodiments disclosed herein.

At least some methods disclosed herein are used for the monitoring of a motor vehicle, wherein the motor vehicle is preferably a passenger car, but may also be a truck. The monitored motor vehicle is preferably parked. The motor vehicle contains a sensor system for detecting vandalism that is inflicted on the motor vehicle by at least one attacking person. If vandalism is detected by means of the sensor system, a warning is issued by the motor vehicle via a user interface of a terminal device associated with the motor vehicle. With this warning, a user of the terminal device is informed of the detected vandalism. The user's terminal device is preferably a mobile device and in particular a mobile phone. Nevertheless, the terminal device can also be any other device with a corresponding user interface, such as a laptop, a tablet or possibly a static computer.

With the method, when the warning is issued via the above user interface of the terminal device, one or more control instructions can also be selected by the user by means of the user interface. In other words, the user interface is designed in such a way that when the warning is issued, the appropriate selection of the control instructions is also made possible by means of appropriate user interaction at the user interface. An action of the motor vehicle is assigned to a respective selectable control instruction, which includes an optical and/or acoustic signal output on the motor vehicle to warn the at least one attacking person. Here and in the following, the term “action” is to be understood broadly. In particular, an action can also comprise a large number of sub-actions which are executed consecutively or, if appropriate, simultaneously, wherein at least one sub-action is an optical or acoustic signal output. An optical or acoustic signal output is to be understood as an output on a motor vehicle that actively generates optical or acoustic signals that can be perceived by the at least one attacking person. When the user selects a particular control instruction by means of the user interface of the terminal device, the action assigned to the selected control instruction is carried out by the motor vehicle when triggered by the terminal device.

At least one method according to the disclosure is characterized in that in the case of vandalism, remote control of the motor vehicle is made possible by the interaction of a user with their terminal device, so that the person or persons who cause the vandalism are deterred by means of an optical or acoustic signal output. In this way, the user can not only detect vandalism at an early stage, but can counteract further exertion thereof by selecting an appropriate control instruction.

If appropriate, in addition to the control instructions described above, which entail an optical or acoustic signal output on the motor vehicle, other types of control instructions may also be selectable on the user interface which do not lead to a corresponding optical or acoustic signal output on the motor vehicle. For example, it may be possible to select a control instruction that establishes a communication link via the terminal device to another interface and in particular to the police, so that the user can inform the police about the vandalism. The police can then drive to the parking location of the motor vehicle and prevent the vandalism there.

The user interface of the terminal device can be designed in different ways. Preferably, the user interface contains a display showing the warning and the selectable control instruction or instructions. The selection of the control instructions is preferably done by touching the control instruction on the display or by the operation of separate buttons on the terminal device. Alternatively or additionally, the user interface can also contain an acoustic input and/or output means and/or a haptic input and/or output means.

In another, particularly preferred embodiment, the selectable control instruction (in the case of only one control instruction) or at least one of the selectable control instructions is associated with the operation of a horn of the motor vehicle and/or the activation of one or more lights of the motor vehicle. These actions represent at least part of the action associated with the corresponding selectable control instruction. In a preferred variant, one or more external lights of the motor vehicle are activated as lights, such as one or more headlamps and/or one or more direction indicators and/or one or more rear lights. Alternatively or additionally, however, one or more internal lights can also be activated for the interior of the motor vehicle.

In another preferred embodiment, the selectable control instruction (in the case of a single control instruction) or at least one of the selectable control instructions is associated with a visual and/or acoustic signal recording on the motor vehicle as part of the assigned action. In other words, in addition to the visual or acoustic signal output, the corresponding control instruction also contains an optical or acoustic signal recording on the motor vehicle. Such a signal recording is to be understood as the acquisition of optical or acoustic signals and their storage. This will document the vandalism appropriately. Preferably, the signal recording on the motor vehicle includes the acquisition of one or more images on the motor vehicle by means of one or more cameras of the motor vehicle, in particular by means of one Or more external cameras for recording the surroundings of the motor vehicle and/or by means of one or more internal cameras for recording the interior or passenger compartment of the motor vehicle. In a particularly preferred variant, a video is recorded by the camera or cameras, which may also include a sound recording of the vandalism.

In a preferred variant of the embodiment just described, during the optical and/or acoustic signal recording on the motor vehicle information is output as an optical and/or acoustic signal output on the motor vehicle, with which the at least one attacking person is informed of the optical and/or acoustic signal recording. By this means a particularly good deterrent to the attacking person is achieved.

The sensor system for detecting vandalism can be designed in different ways. In a particularly preferred embodiment, the sensor system contains an accelerometer, which can be used to detect shocks or blows very well by means of acceleration signals, so that vandalism can be reliably detected. In a preferred variant, a single accelerometer is provided, which saves costs. In another preferred variant, the accelerometer is installed in the roof of the vehicle. This central installation location ensures the detection of blows and shocks very well in the event of vandalism in all parts of the vehicle. Alternatively, the accelerometer may be installed elsewhere in the motor vehicle, or one or more additional accelerometers may be provided in locations other than the roof of the motor vehicle. For example, an accelerometer can also be integrated into the bonnet or rear of the vehicle.

In another preferred embodiment, the sensor system for detecting vandalism is used to detect the strength of successive shocks and/or the time intervals between successive shocks, wherein in this case the sensor system preferably includes the accelerometer described above. Vandalism is detected by the sensor system when the strength of the successive shocks and/or the time intervals between the successive shocks meet a predetermined criterion. This embodiment is based on the knowledge that the magnitudes of the strength of the shocks or the time intervals between the shocks enable very good conclusions as to whether the force on the motor vehicle is due to vandalism or whether it has other causes, such as a force from an accident.

In a preferred variant of the embodiment just described, according to the predetermined criterion, vandalism is detected if a minimum number of time intervals between successive shocks within a predetermined period of time deviates by more than a predetermined time threshold value from the average of the time intervals between successive shocks within the predetermined period of time and/or if the strength of a minimum number of shocks within a given period of time deviates by more than a given shock strength threshold value from the average of the strength of the shocks within the specified time period. This embodiment takes advantage of the knowledge that vandalism is associated with blows of varying severity and a certain irregularity. Where appropriate, other or different conditions may also be included in the predetermined criterion for the detection of vandalism. For example, in order to detect vandalism, it may be necessary for the strength of all shocks in a certain period of time to exceed a predetermined value.

In addition to the method described above, the disclosure relates to an arrangement of a motor vehicle and a terminal device, wherein the arrangement (i.e. the motor vehicle and the terminal device) is set up to carry out the method discussed above, or one or more preferred variants of the method discussed above.

The disclosure also relates to a motor vehicle which is set up to operate as a motor vehicle with the method discussed above, or one or more preferred variants of the method discussed above.

The disclosure also relates to a terminal device which is set up to work as a terminal device with the method as discussed above, or with one or more preferred variants of the method discussed above.

### BRIEF DESCRIPTION OF THE DRAWING

FIG. 1 shows a schematic representation of a motor vehicle and a terminal device in accordance with at least one embodiment.

### DETAILED DESCRIPTION

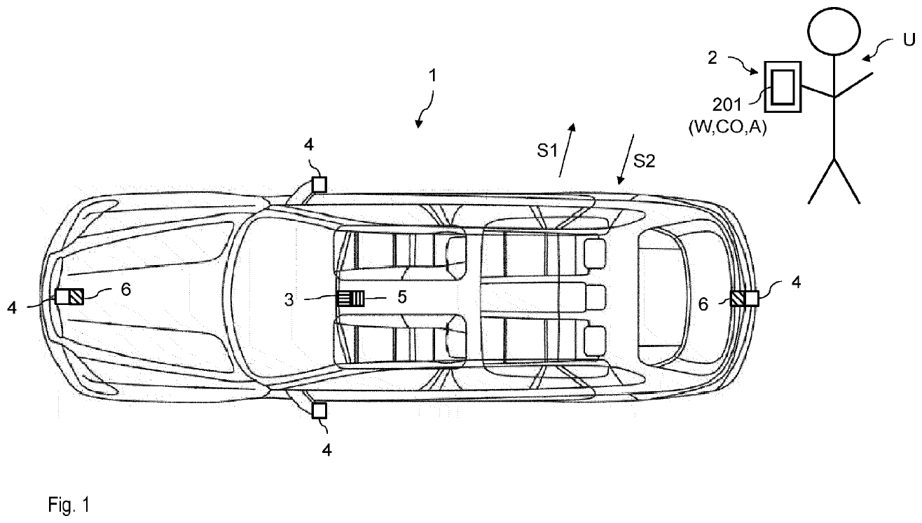

An exemplary embodiment is described in detail below on the basis of the attached FIG. 1. This figure shows in a schematic representation a motor vehicle and a terminal device with which an embodiment of the method discussed above is carried out.

In FIG. 1 a parked motor vehicle 1 is schematically reproduced in plan view from above, wherein only components of the motor vehicle which are essential are explained below. In addition, FIG. 1 shows in a schematic representation a terminal device 2 which contains a user interface in the form of a display 201, wherein the terminal device is operated by a user U.

The motor vehicle 1 contains a sensor system 3 with an accelerometer. In FIG. 1, this sensor system is schematically represented by a square with horizontal hatching. The sensor system 3 is integrated into the roof of the motor vehicle and enables the detection of vandalism by means of a processor (not shown). The motor vehicle also comprises four external cameras, which are marked with reference sign 4 and are schematically indicated by white squares. One external camera is located in the middle of the front of the motor vehicle, an external camera is installed in the right external mirror of the motor vehicle, another external camera is installed in the left external mirror of the motor vehicle and another external camera is located in the middle of the rear of the motor vehicle. In a well-known way, the external cameras can be used to capture a 360° all-round view of the motor vehicle.

In addition to the external cameras 4, the motor vehicle 1 contains an internal camera 5 integrated into the interior cladding of the roof, which is schematically indicated as a square with vertical hatching. This camera can be used to record the interior of the motor vehicle. In addition, the motor vehicle 1 contains corresponding external loudspeakers 6 in the centre of the front and in the centre of the rear, by means of which acoustic signals can be emitted to the outside. These external loudspeakers are schematically indicated by squares with oblique hatching. In addition, several internal loudspeakers are provided in the interior of the motor vehicle, which are not shown for reasons of clarity and are integrated, for example, in the access doors to the interior of the motor vehicle.

The number and positions of the components just described (i.e. the sensor system, the external and internal cameras and the external and internal speakers) are only exemplary and can also be chosen differently.

Communication can take place between the motor vehicle 1 and terminal device 2 by means of a known communication infrastructure, as will be explained in more detail below. For this purpose, both the motor vehicle 1 and the terminal device 2 have a communication interface. In the embodiment described here, the terminal device 2 is a mobile terminal device in the form of a smartphone, the display of which can be operated by the depicted user U. Alternatively, the device can also be a different device, such as a tablet, a laptop, a PC with a user interface and the like.

The method described below serves to deter an attacking person who is inflicting vandalism on the parked motor vehicle 1 and also to document the vandalism by means of an image recording. When blows are inflicted on the motor vehicle 1, these are recorded as shocks by the accelerometer of the sensor system 3. The strength of the blows and the time span between consecutive blows are stored. A suitable criterion is then used to determine whether the blows can be classified as vandalism. As already mentioned above, the criterion can be designed in such a way that vandalism is detected only if a minimum number of time intervals between successive shocks within a predetermined period of time deviates by more than a predetermined time threshold value from the average of the time intervals between successive shocks within the predetermined period of time and/or if the strength of a minimum number of shocks within a given period of time differs from the average of the strength of the shocks within the specified period of time by more than a predetermined strength of shock threshold value. This takes advantage of the fact that in vandalism blows or shocks occur with variable intensity and a certain irregularity. The criterion for detecting vandalism may also be designed differently or contain further requirements. For example, the absolute strength of the blows can also be taken into account, wherein vandalism is only detected if a predetermined percentage of the blows and, if applicable, all blows exceed a certain threshold.

If vandalism is detected by the sensor system 3 of the motor vehicle 1, a certain representation is generated on the display 201 of the terminal device 2 according to step S1, which is indicated by an arrow, and triggered by the motor vehicle 1. To achieve this, the motor vehicle sends out a suitable message via a wireless communication interface. This message triggers the transmission of a further message to the terminal device 2 in a backend (not shown). This further message is received by the terminal device 2 via a wireless communication interface and triggers the generation of the corresponding display. The display includes a warning message W, with which the user U is informed that vandalism is currently being inflicted on their vehicle 1. The display can be generated by a suitable app on the terminal device 2, for example.

In addition to the warning W, control instructions are shown on the display 201, for example in the form of textual and/or graphical information. These control instructions are generally indicated in FIG. 1 by reference sign CO and the user can select one or more of the control instructions. For this purpose, each control instruction is assigned a field for selecting the control instruction on the display 201, wherein the control instruction can be within the field. The user can select the corresponding control instruction by tapping on a field with their finger.

Each control instruction CO is associated with an action, wherein the actions in FIG. 1 are generally denoted by reference sign A. The actions are actions which the motor vehicle can carry out independently. The action is then carried out when the user U selects the appropriate control instruction on the display 201. Several of the actions A each include an optical and/or acoustic signal output on the motor vehicle.

If a control instruction is selected by the user U, step S2, indicated by an arrow, is carried out, which causes the execution of the corresponding action in the motor vehicle 1. For this purpose, the terminal device 2 transmits a corresponding message to the backend already mentioned above, which in turn transmits another message to the motor vehicle 1, wherein the further message triggers the corresponding action on the motor vehicle.

In the embodiment described here, one of the control instructions concerns the action of the motor m vehicle beginning to operate the horn and at the same time the external lights and, if necessary, the internal lights of the motor vehicle are activated. For example, the headlights and/or taillights and/or direction indicators of the motor vehicle may flash intermittently. This action is a suitable deterrent to the attacker who is inflicting the vandalism on the motor vehicle 1, since the motor vehicle attracts the attention of other persons in the vicinity. Often this leads to the attacker ending the vandalism and fleeing.

In the embodiment described here, a further selectable control instruction concerns the action that a video is captured by means of the external cameras 4 and stored, wherein the video can be stored locally in the motor vehicle or the stored video can also be uploaded immediately by the motor vehicle to a remote server. The recording of the video serves to document the vandalism, wherein images of the attacker may also be captured so that they can be identified. In addition to the external cameras 4, the internal camera 5 can also be switched on to document the vandalism. In parallel with the video recording, an automatic voice output is also generated via the external speakers 6 as part of the action by the motor vehicle and, if necessary, also the internal speakers. With the voice output, the attacker is informed that their vandalism is currently being recorded by cameras. This, in turn, deters the attacking person, so the person is likely to stop the vandalism immediately and flee.

The embodiments described above have a number of advantages. In particular, it is possible for the user of a motor vehicle not only to be informed of vandalism by means of their terminal device, but also allows the user to determine what actions are to be carried out on the motor vehicle in the event of such vandalism. The actions include optical and/or acoustic signal output, which is used to deter the attacking person. This deterrence usually leads to the attacker ending the vandalism.

### LIST OF REFERENCE SIGNS

1 Motor vehicle
2 Terminal device
201 User interface (display)
3 Sensor system for detecting vandalism
4 External cameras
5 Internal camera
6 External Speaker
S1, S2 Steps
U User
W Warning
CO Control Instructions
A Actions

1.-13. (canceled)

14. A method for monitoring a motor vehicle, wherein the motor vehicle contains a sensor system for detecting vandalism which is inflicted on the motor vehicle by at least one attacking person, the method comprising:
issuing a warning via a user interface of a terminal device assigned to the motor vehicle to inform a user of the detected vandalism,
enabling one or more control instructions to be selected by the user of the user interface when the warning is issued,
wherein an action of the motor vehicle is assigned to a respective selectable control instruction, said action including a visual and/or acoustic signal output on the motor vehicle for warning the at least one attacking person, and
wherein, triggered by the terminal device, when a first respective control instruction is selected by the user, the action assigned to the first respective selected control instruction is carried out by the motor vehicle.

15. The method as claimed in claim 14, wherein the user interface comprises a display on which the warning and the one or more selectable control instructions are displayed.

16. The method as claimed in claim 14, wherein the first selectable control instruction is assigned, as at least a part of the action, an operation of a horn of the motor vehicle or an activation of one or more lights of the motor vehicle.

17. The method as claimed in claim 14, wherein the selectable control instruction is assigned, as at least a part of the action, an operation of a horn of the motor vehicle and an activation of one or more lights of the motor vehicle.

18. The method as claimed in claim 14, wherein the first selectable control instruction is assigned, as a part of the action, performing a recording on the motor vehicle, wherein the recording is at least one of the group consisting of an optical signal recording and an acoustic signal recording.

19. The method as claimed in claim 18, wherein performing the recording includes acquiring one or more images on the motor vehicle using one or more cameras of the motor vehicle.

20. The method as claimed in claim 18, wherein during the performing of the recording, on the motor vehicle, information is output as an optical signal output or acoustic signal output on the motor vehicle which is configured to inform the at least one attacking person of the recording.

21. The method as claimed in claim 14, wherein the sensor system for detecting the vandalism comprises at least one accelerometer.

22. The method as claimed in claim 21, wherein the at least one accelerometer consists of a single accelerometer.

23. The method as claimed in claim 21, wherein at least a first accelerometer of the at least one accelerometer is installed in a roof of the motor vehicle.

24. The method as claimed in claim 14, wherein a strength of successive shocks or time intervals between the successive shocks are detected using the sensor system for detecting vandalism, and
further comprising determining that vandalism is occurring if an intensity of the successive shocks or the time intervals between the successive shocks meet a predetermined criterion.

25. The method as claimed in claim 24, wherein according to the predetermined criterion, the vandalism is detected if a minimum number of time intervals between the successive shocks within a predetermined period of time deviates from an average of the time intervals between successive shocks within the predetermined period of time.

26. The method as claimed in claim 24, wherein according to the predetermined criterion, the vandalism is detected if a strength of a minimum number of shocks within a given time period deviates by more than a specified shock intensity threshold value from an average of the strength of shocks within the given time period.

27. The method as claimed in claim 14, wherein a strength of successive shocks and time intervals between the successive shocks are detected using the sensor system for detecting the vandalism, and
further comprising determining that the vandalism is occurring if an intensity of the successive shocks or the time intervals between the successive shocks meet a predetermined criterion.

28. The method as claimed in claim 14, wherein a strength of successive shocks and time intervals between the successive shocks are detected using the sensor system for detecting the vandalism, and
further comprising determining that the vandalism is occurring if an intensity of the successive shocks and the time intervals between the successive shocks meet corresponding predetermined criteria.

29. A motor vehicle, comprising:
a sensor system for detecting vandalism which is inflicted on the motor vehicle by at least one attacking person, wherein the motor vehicle is configured to:
cause a warning to be issued via a user interface of a terminal device assigned to the motor vehicle to inform a user of the detected vandalism,
receive from the terminal device a first of one or more control instructions selected by the user of the user interface when the warning is issued,
wherein an action of the motor vehicle is assigned to a respective selectable control instruction, said action including a visual and/or acoustic signal output on the motor vehicle for warning the at least one attacking person, and
carry out the action assigned to the respective selected control instruction.

30. A terminal device for monitoring a motor vehicle, wherein the motor vehicle contains a sensor system for detecting vandalism which is inflicted on the motor vehicle by at least one attacking person, the terminal device configured to:
issuing a warning via a user interface to inform a user of the detected vandalism,
enabling a first control instruction of one or more control instructions to be selected by the user of the user interface when the warning is issued, wherein an action of the motor vehicle is assigned to a respective selectable control instruction, said action including a visual and/or acoustic signal output on the motor vehicle for warning the at least one attacking person, and
trigger the motor vehicle to carry out the action assigned to the first control instruction.
